(19) United States
(12) Patent Application Publication
(10) Pub. No.: US 2018/0107764 A1
(43) Pub. Date: Apr. 19, 2018

(54) GRAPH COMPARISON FOR CONFLICT RESOLUTION

(71) Applicant: Brigham Young University, Provo, UT (US)

(72) Inventors: Kelly Eric Bowman, Provo, UT (US); Devin Shumway, Sandy, UT (US); John Salmon, Provo, UT (US)

(21) Appl. No.: 15/786,391

(22) Filed: Oct. 17, 2017

Related U.S. Application Data
(60) Provisional application No. 62/409,224, filed on Oct. 17, 2016.

(51) Int. Cl. G06F 17/50

(52) U.S. Cl. CPC G06F 17/50; G06F 2217/04

(57) ABSTRACT

An apparatus includes an editing module that composes a first hierarchical dependency tree for a first local object model stored on a first client, the first local object model corresponding to a shared object model of an engineering object, and further composes a second hierarchical dependency tree for a second local object model stored on a second client, the second local object model corresponding to the shared object model. The apparatus includes a dependency tree module that compares the first hierarchical dependency tree to the second hierarchical dependency tree. Moreover, the apparatus includes a merging module that automatically merging a first change to the first local object model and a second change to the second local object model in the shared object model below a common antecedent node.

### CROSS REFERENCE TO RELATED APPLICATIONS

The present application is a Non-Provisional Patent Application that claims priority to U.S. Provisional Application No. 62/409,224, filed on Oct. 17, 2016, which is incorporated herein by reference in its entirety.

### STATEMENT AS TO RIGHTS TO INVENTIONS MADE UNDER FEDERALLY SPONSORED RESEARCH AND DEVELOPMENT

This invention was made with government support under Grant Number R0602349 awarded by the National Science Foundation Center for Edesign. The government has certain rights in the invention

### FIELD

The subject matter disclosed herein relates to collaborative projects, and more particularly relates to conflict resolution in collaborative projects.

### BACKGROUND

Computer-aided systems such as computer-aided design, engineering, analysis, and manufacture (collectively, CAx) historically have enabled individual designers to work on an electronic model of a design object, or a portion thereof. Most design projects, however, require collaboration between several designers. The primary challenge in developing a CAx system that can accommodate multiple users is preventing conflicts and design inconsistencies as multiple users work on a single shared model.

To accommodate the needs of multiple users, CAx systems have utilized collaborative CAx systems. Collaborative CAx systems store copies of a design model on each of the clients. In some cases, conflicts develop between the different copies of the design model, requiring manual resolution of the conflicts and the potential loss of previous design operations. Resolving conflicts can be time and resource intensive.

Given the foregoing, additional and improved systems and methods for resolving conflicts are called for. The embodiments disclosed herein were developed in response to, among other things, these issues.

### BRIEF SUMMARY

An apparatus is disclosed. A method and computer program product also perform the functions of the apparatus. In one embodiment, an apparatus includes an editing module that composes a first hierarchical dependency tree for a first local object model stored on a first client, the first local object model corresponding to a shared object model of an engineering object, and further composes a second hierarchical dependency tree for a second local object model stored on a second client, the second local object model corresponding to the shared object model. The apparatus includes a dependency tree module that compares the first hierarchical dependency tree to the second hierarchical dependency tree. Moreover, the apparatus includes a merging module that automatically merging a first change to the first local object model and a second change to the second local object model in the shared object model below a common antecedent node.

A method, in one embodiment, includes composing a first hierarchical dependency tree for a first local object model stored on a first client, the first local object model corresponding to a shared object model of an engineering object and composing a second hierarchical dependency tree for a second local object model stored on a second client, the second local object model corresponding to the shared object model. The method includes comparing the first hierarchical dependency tree to the second hierarchical dependency tree. In some embodiments, the method includes automatically merging a first change to the first local object model and a second change to the second local object model in the shared object model below a common antecedent node.

In one embodiment, a computer program product includes a computer readable storage medium having program instructions embodied therewith. The program instructions, in some embodiments, are executable by a processor to cause the processor to compose a first hierarchical dependency tree for a first local object model stored on a first client, the first local object model corresponding to a shared object model of an engineering object. The program instructions, in one embodiment, are executable by a processor to cause the processor to compose a second hierarchical dependency tree for a second local object model stored on a second client, the second local object model corresponding to the shared object model. The program instructions, in one embodiment, are executable by a processor to cause the processor to compare the first hierarchical dependency tree to the second hierarchical dependency tree. The program instructions, in one embodiment, are executable by a processor to cause the processor to automatically merge a first change to the first local object model and a second change to the second local object model in the shared object model below a common antecedent node.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for conflict resolution for dependency trees, in accordance with some embodiments of the present invention;

FIG. 2 is a schematic diagram illustrating one embodiment of a system for conflict resolution for dependency tree graphs, in accordance with some embodiments of the present invention;

FIG. 3 is a schematic block diagram illustrating one embodiment of modules for tree conflict resolution apparatus, in accordance with some embodiments of the present invention;

FIG. 4 is a schematic block diagram illustrating one embodiment of a hierarchical dependency tree, in accordance with some embodiments of the present invention;

FIG. 5 is a schematic block diagram illustrating one embodiment of a hierarchical dependency tree, in accordance with some embodiments of the present invention; and

FIG. 6 is a schematic flow chart diagram illustrating one embodiment of a method for resolving conflicts, in accordance with some embodiments of the present invention.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure may refer to elements of proceeding figures. Like numbers refer to like elements in all figures, including alternate embodiments of like elements.

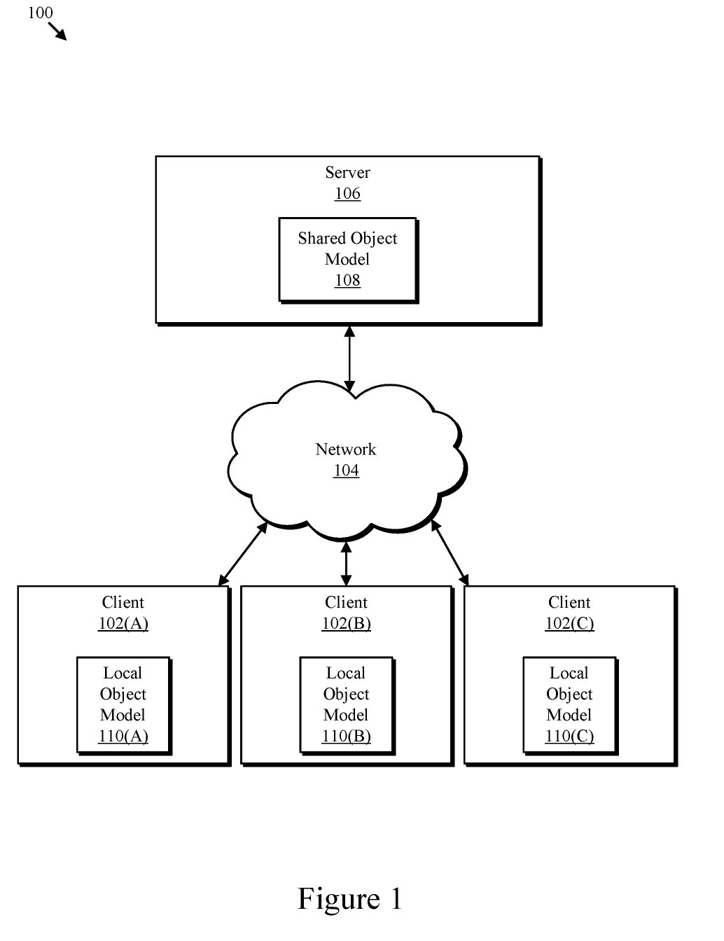

FIG. 1 is a schematic drawing of a system 100 wherein multi-user CAx editing may be deployed. As illustrated in this figure, system 100 may include one or more clients 102(A), 102(B), and 102(C) (or generally 102), a network 104, and a server 106. Server 106 may host a shared (i.e., global) object model 108. Clients 102 may host local model copies 110(A), 110(B), and 110(C) (or generally 110) that include at least of portion of shared object model 108. In another example, clients 102 may not host local copies of engineering model data, instead accessing data from shared object model 108 on server 106. In another example, each client 102 may have a copy of all or part of the object model database, with features of the CAx system controlling the portion of the database available for editing by each user.

Clients 102 generally represent any type or form of computing device capable of reading computer-executable instructions. Examples of clients 102 include, without limitation, laptops, tablets, desktops, servers, combinations of one or more of the same, or any other suitable computing device.

Server 106 generally represents any type or form of computing device or combinations of computing devices that is capable of storing, comparing, and/or providing data, as well as providing back-end processing services. Server 106 may represent a commercial or publicly-accessible service or a service provided to a single organization. Examples of server 106 include, without limitation, high-performance clusters, virtual machines, application servers, web servers, and/or database servers configured to provide various database services and/or run software applications, or combinations of one or more of the same.

In certain embodiments, server 106 may represent combinations of software applications and physical computing systems configured to perform various tasks. For example, server 106 may include a database server that manages one or more databases, such as shared object model 108. In one example, shared object model 108 may be configured to store geometry, material, load, and/or environment data representing one or more design models. Shared object model 108 may represent portions of a single database or computing device or a plurality of databases or computing devices capable of being accessed by computing devices included in server 106 and/or clients S102.

Network 104 generally represents any medium or architecture capable of facilitating communication or data transfer. Examples of network 104 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), or the like. Network 104 may facilitate communication or data transfer using wireless or wired connections. In one embodiment, network 104 may facilitate communication between clients 102 and server 106.

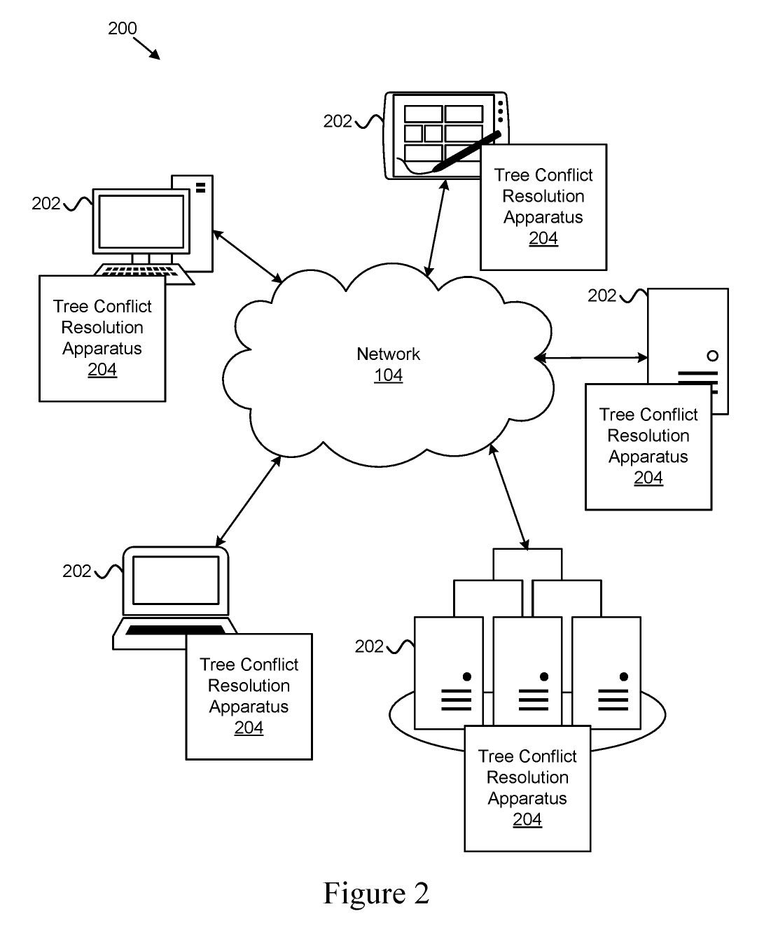

FIG. 2 depicts one embodiment of a system 200 for conflict resolution for dependency tree graphs. In one embodiment, the system 200 includes information handling devices 202, tree conflict resolution apparatuses 204, and networks 104. Even though a particular number of information handling devices 202, tree conflict resolution apparatuses 204, and networks 206 are depicted in the system 200 of FIG. 2, one of skill in the art will recognize that any number or configuration of information handling devices 202, tree conflict resolution apparatuses 204, and networks 206 may be present in the system 200.

The information handling devices 202, in certain embodiments, include computing devices, such as desktop computers, laptop computers, tablet computers, smart phones, smart televisions, smart watches, or the like. The information handling devices 202 may also include servers, such as web servers, application servers, file servers, media servers, email servers, cloud servers, backup servers, virtual servers, computer-aided design (“CAD”) servers, or the like. In some embodiments, the information handling devices 202 may be part of a data center used for data storage, data backup, data replication, disaster recovery, and/or the like. The information handling devices 202 may be located in geographically remote locations, in the same geographic location (e.g., the same data center), or some combination of both.

The information handling devices 202 may be configured to store data, backup data, replicate data, or the like. For example, the information handling devices 202 may be configured to perform synchronous or asynchronous data replication. In another example, information handling devices 202 may be configured as failover devices for one or more associated production information handling devices 202. Moreover, the information handling devices 202 may comprise one or more storage volumes, storage devices, redundant array of independent disks (“RAID”) devices or configurations, or the like, such as hard-disk drives, solid-state drives, flash memory devices, random-access memory (“RAM”), serial advanced technology attachment (“SATA”) devices, tape devices, or the like. In some embodiments, the information handling devices 202 are in communication via one or more data networks 206, described below.

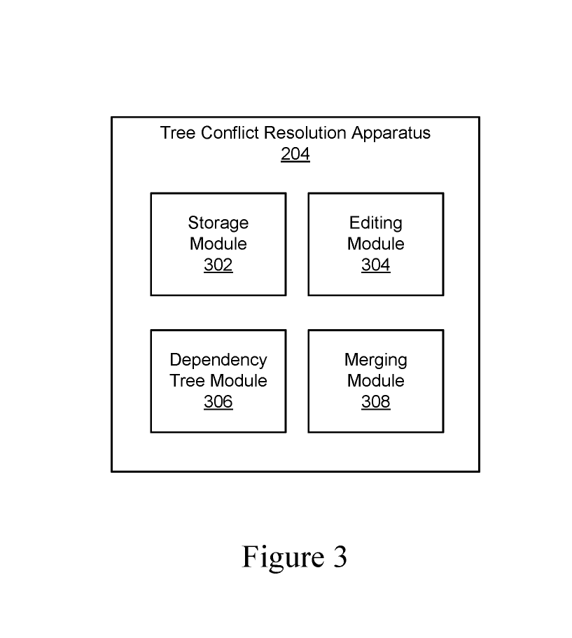

In one embodiment, the tree conflict resolution apparatus 204 receives data from multiple client applications in a collaborative environment. In such an embodiment, the data may be in a client specific format. In certain embodiments, the tree conflict resolution apparatus 204 receives one or more hierarchical dependency trees from each client application of the multiple client applications. In some embodiments, the tree conflict resolution apparatus 204 converts the data relating to a local object model 110 from the client 102 to a hierarchical dependency tree. In some embodiment, the tree conflict resolution apparatus 204 converts the data relating to the local model object 110 from a specific format to a generic format. In one embodiment, the tree conflict resolution apparatus 204 stores the hierarchical dependency tree. In certain embodiments, the tree conflict resolution apparatus 204 converts the data from the generic format to the client specific format. In some embodiments, the tree conflict resolution apparatus 204 provides the hierarchical dependency tree to the multiple client applications based on the one or more requests. In this manner, the tree conflict resolution apparatus 204 may allow a large number of users that may be using different applications to collaboratively participate in modifying the hierarchical dependency tree by modifying local object models 110. In certain embodiments, as described below with reference to FIG. 3, the tree conflict resolution apparatus 204 includes multiple modules that perform the operations of the tree conflict resolution apparatus 204.

The data network or network 104, in one embodiment, includes a digital communication network that transmits digital communications. The network 104 may include a wireless network, such as a wireless cellular network, a local wireless network, such as a Wi-Fi network, a Bluetooth® network, a near-field communication (“NFC”) network, an ad hoc network, and/or the like. The network 104 may include a wide area network (“WAN”), a storage area network (“SAN”), a local area network (“LAN”), an optical fiber network, the internet, or other digital communication network. The network 104 may include two or more networks. The network 104 may include one or more servers, routers, switches, and/or other networking equipment. The network 104 may also include computer readable storage media, such as a hard disk drive, an optical drive, non-volatile memory, random access memory (“RAM”), or the like.

FIG. 3 is a schematic block diagram illustrating one embodiment of a module for conflict resolution for dependency tree graphs. In one embodiment, the module includes an embodiment of a tree conflict resolution apparatus 204. The Tree conflict resolution apparatus 204, in various embodiments, includes one or more of a storage module 302, an editing module 304, a dependency tree module 306, and a merging module 308, which are described in more detail below.

In one embodiment, the storage module 302 stores a shared object model at a server. In one embodiment, the storage module 302 stores a first local object model on a first client and a second local object model on a second client.

In one embodiment, the storage module 302 stores the hierarchical dependency tree. The hierarchical dependency tree may be a data format that facilitates use by multiple different types of client applications. For example, the hierarchical dependency tree may be a standardized format to which all client specific formats are converted before the data is stored so that the hierarchical dependency tree may be converted into client specific formats. In some embodiments, the storage module 302 includes a database and the generic format of the hierarchical dependency tree may be stored in the database. In various embodiments, the database may operate with referential integrity. For example, to operate with referential integrity the data in the database may require every value of one attribute (e.g., column) of a relation (e.g., table) to exist as a value of another attribute in a different relation (e.g., table).

The storage module 302 may store the hierarchical dependency tree in any suitable device, such as a one or more storage volumes, storage devices, RAID devices or configurations, or the like, such as hard-disk drives, solid-state drives, flash memory devices, RAM, SATA devices, tape devices, or the like.

In one embodiment, the storage module 302 receives hierarchical dependency tree data from multiple client applications in a collaborative environment. In some embodiments, the hierarchical dependency tree data may be in a client specific format. The hierarchical dependency tree data may include one or more of CAD data generated by any suitable CAD software application. In addition, the CAD software application may be produced by any suitable manufacturer. Accordingly, the storage module 302 may receive data output in a variety of client specific formats (e.g., data formats that are specific to a software application that produces the data) from a variety of engineering tools, CAD software applications, and management software applications.

The editing module 304, in some embodiments, receives requests from one or more client applications of the multiple client applications. A request may be a request for particular hierarchical dependency tree data that is used by the respective client application. In some embodiments, the request solicits a change to a hierarchical dependency tree based on editing to a local object model. For example, as a local object model is edited, a hierarchical dependency tree corresponding to the local object model is automatically updated with the edits. In some embodiments, the hierarchical dependency tree is built or composed after edits occur on the local object model.

In some embodiments, the editing module 304 composes a first hierarchical dependency tree for a first local object model stored on a first client, the first local object model corresponding to a shared object model. In some embodiments, the first hierarchical dependency tree is composed from editing a global hierarchical dependency tree corresponding to the shared object model. In some embodiments, a global hierarchical dependency tree corresponds to the shared object model and each local object model on each client corresponds to a separate hierarchical dependency tree.

In some embodiments, the editing module 304 composes a second hierarchical dependency tree for a second local object model stored on a second client, the second local object model corresponding to a shared object model. In some embodiments, the second hierarchical dependency tree is composed from editing a global hierarchical dependency tree corresponding to the shared object model.

In some embodiments, the editing module 304 applies a change or a plurality of changes to a first local object model. In some embodiments, the editing module 304 automatically determines a corresponding change to a first hierarchical dependency tree corresponding to the first local object model based on the change or the plurality of changes to the first local object model. In some embodiments, the editing module 304 applies the change or the plurality of changes to the first hierarchical dependency tree corresponding to the first local object model. In some embodiments, the editing module builds or composes the first hierarchical dependency tree based on the local object model and the change or the plurality of changes to the first local object model.

In some embodiments, the editing module 304 applies a change or a plurality of changes to a second local object model. In some embodiments, the editing module 304 automatically determines a corresponding change to a second hierarchical dependency tree corresponding to the second local object model based on the change or the plurality of changes to the second local object model. In some embodiments, the editing module 304 applies the change or the plurality of changes to the second hierarchical dependency tree corresponding to the second local object model. In some embodiments, the editing module builds or composes the second hierarchical dependency tree based on the second local object model and the change or the plurality of changes to the second local object model.

Updates to the hierarchical dependency tree may occur immediately (i.e., without intended hesitation) and may occur in real-time from the perspective of the user. As may be appreciated, immediate updates may also be considered real-time updates, near real-time updates, substantially real-time updates, dynamic updates, and so forth. For example, immediate updates to the hierarchical dependency tree may be provided automatically within seconds or minutes of a modification to local object model being made. Moreover, immediate updates to the hierarchical dependency tree may operate in a collaborative environment such that when modifications to the local object model are made, stored, and/or saved, the modifications are provided to other users editing other local object models.

In contrast, deferred updates to the hierarchical dependency tree may occur. Deferred updates may be considered selective updates, non-real time updates, delayed updates, and so forth. For example, deferred updates to the hierarchical dependency tree may be provided at a scheduled time, when computer resources are sufficient, upon selection, on-demand, and so forth. Moreover, deferred updates to the hierarchical dependency tree may operate in a collaborative environment such that when modifications to the local model object are made and/or saved, the modifications are not immediately provided, but are stored to be provided to at a later time, such as in batches.

The dependency tree module 306, in certain embodiments, compares the first hierarchical dependency tree to the second hierarchical dependency tree. In some embodiments, the dependency tree module 306 compares a first graphical hierarchical dependency tree to a second graphical hierarchical dependency tree to determine the differences between the first graphical hierarchical dependency tree and the second graphical hierarchical dependency tree. Comparing graphs of the hierarchical dependency trees can be done in a variety of manners. In one embodiment, the graphs are combined to determine inconsistencies between the first graphical hierarchical dependency tree and the second graphical hierarchical dependency tree. In one embodiment, indicated changes on each of the first graphical hierarchical dependency tree and the second graphical hierarchical dependency tree are determined and compared. In one embodiment, the entire graphs (or graphical hierarchical dependency trees) are compared. In some embodiments, only a portion of the graphs are compared.

The dependency tree module 306, in certain embodiments, compares the first hierarchical dependency tree to the second hierarchical dependency tree by first determining a first branch of the first hierarchical dependency tree upon which changes have been made. Then the dependency tree module 306 determines a second branch of the second hierarchical dependency tree upon which changes have been made. After both branches, the first branch and the second branch, have been determined, the dependency tree module 306 determines an intersection of the first branch of the first hierarchical dependency tree and the second branch of the second hierarchical dependency tree. The intersection of the first branch of the first hierarchical dependency tree and the second branch of the second hierarchical dependency tree is a common antecedent node (or common ancestor) of the changes. The common antecedent node is the point at which the changes in each hierarchical dependency tree overlap. All changes below the common antecedent node can be changed without error checking as the changes are compatible based on the hierarchical dependency trees. In other words, determining the common antecedent node determines that no conflict will occur to changes made below on the hierarchical dependency tree. The changes made to the local object models can be directly applied to the shared object model.

In one embodiment, the merging module 308 automatically merges a first change to the first local object model and a second change to the second local object model in the shared object model below a common antecedent node. The changes can be automatically applied to the shared object model without checking all part and feature dependencies. As not all dependencies need to be checked for consistency, merging changes from separate local object models can be done quickly and efficiently. This is particularly useful in the client/server situation as the information and data is transmitted back and forth from client and server. Data relating to all dependencies need not be transmitted. The merging of changes can be done automatically if all changes are below the common antecedent node.

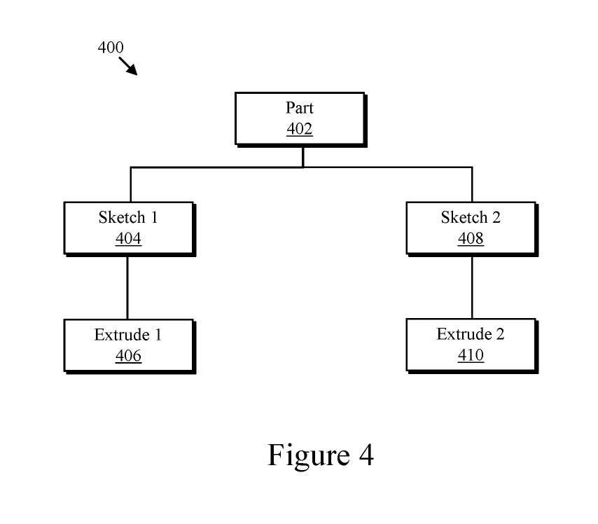

FIG. 4 is a schematic block diagram illustrating one embodiment of a first hierarchical dependency tree 400. The first hierarchical dependency tree 400 includes hierarchical dependencies between features. Although the first hierarchical dependency tree 400 is a simplified hierarchical dependency tree, the components and processes described herein apply to more complex hierarchical dependency trees. In addition, although the first hierarchical dependency tree 400 relates to a part model, embodiments described herein are applicable to assemblies with multiple parts in which dependencies can be mapped into a hierarchical dependency tree.

Referring to FIG. 4, the first hierarchical dependency tree 400 includes an overall part 402 that includes a first sketch 404 and a second sketch 408. The first sketch 404 includes a first extrude 406 and the second sketch 408 includes a second extrude 410. The first extrude 406 is dependent on the first sketch 404 and the second extrude 410 is dependent on the second sketch 408. Each of the first sketch 404 and the second sketch 408 are dependent on the overall part 402. With these dependencies mapped, the first hierarchical dependency tree 400 depicts that the first sketch 404 and the second sketch 408 can be independently edited without affecting the other.

Referring to the first hierarchical dependency tree 400, in an example, changes are made to the first sketch 404 on a first local object model on a first server. The first hierarchical dependency tree 400, in this example, includes an edited first sketch 404 which edits have occurred on a first client. The changes to the first sketch 404 show that there are changes made to a first branch of the first hierarchical dependency tree 400. The first branch extends down from part 402 thru first sketch 404 and finally to first extrude 406.

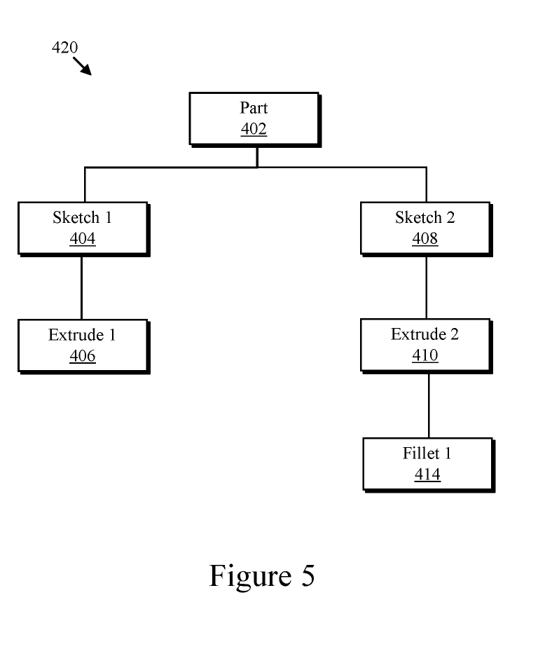

FIG. 5 is a schematic block diagram illustrating one embodiment of a second hierarchical dependency tree. The second hierarchical dependency tree 420 includes hierarchical dependencies between features. Although the second hierarchical dependency tree 420 is a simplified hierarchical dependency tree, the components and processes described herein apply to more complex hierarchical dependency trees. In addition, although the second hierarchical dependency tree 420 relates to a part model, embodiments described herein are applicable to assemblies with multiple parts in which dependencies can be mapped into a hierarchical dependency tree.

Referring to FIG. 5, the second hierarchical dependency tree 420 includes all the same features as the first hierarchical dependency tree 400. The second hierarchical dependency tree 420 includes an overall part 402 that includes a first sketch 404 and a second sketch 408. The first sketch 404 includes a first extrude 406 and the second sketch 408 includes a second extrude 410. The first extrude 406 is dependent on the first sketch 404 and the second extrude 410 is dependent on the second sketch 408. The first fillet 414 is dependent on the second extrude 410. The second hierarchical dependency tree 420 includes changes indicating that a first fillet 414 has been applied to the second extrude 410. The first fillet 414 is dependent on the second extrude 410.

Referring to the second hierarchical dependency tree 420, in an example, changes are made to the second extrude 410 by applying a fillet 414 on a second local object model on a second server. The changes to the second extrude 410 by applying a fillet 414 show that there are changes made to a second branch of the second hierarchical dependency tree 420. The second branch extends down from part 402 thru second sketch 408 and second extrude 410 and finally to fillet 414.

Referring now to FIGS. 4 and 5, the first hierarchical dependency tree 400 and the second hierarchical dependency tree 420 are compared. As the dependency trees are compared the first branch and the second branch are compared to determine an intersection between the branches. The first branch and the second branch intersect at a common antecedent node at part 402. After comparing the first hierarchical dependency tree 400 and the second hierarchical dependency tree 420, the changes can be automatically merged onto the shared object model as the changes occur on separate branches below the common antecedent node. There is no need for any pessimistic error checking by checking all dependencies. The graphs are compared and changes below the common antecedent node are automatically applied. Any changes above the common antecedent node would not be applied.

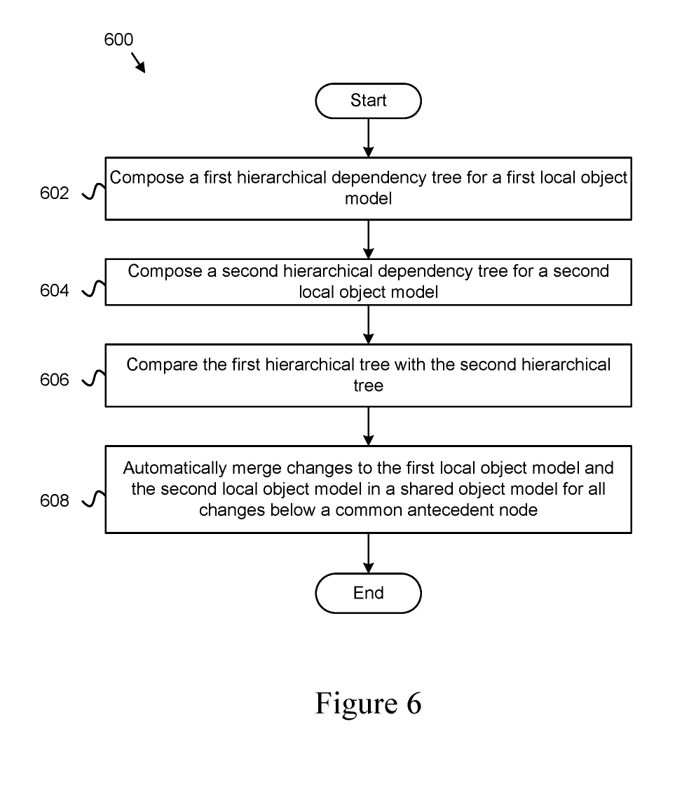

FIG. 6 is a schematic flow chart diagram illustrating one embodiment of a method 600 for merging changes in collaborative environments. The method 600 begins and the Tree conflict resolution apparatus 204 composes 602 a first hierarchical dependency tree for a first local object model stored on a first client, the first local object model corresponding to a shared object model of an engineering object. In certain embodiments, the first hierarchical dependency tree is in a client specific format. In some embodiments, the editing module 304 composes 602 the first hierarchical dependency tree from a master hierarchical dependency tree and any changes made to the local object model on the client. All changes made to the local object model are depicted on the hierarchical dependency tree and a first hierarchical dependency tree is composed for the first client. In one embodiment, the hierarchical dependency tree may include feature and part dependencies for the first local object model.

The Tree conflict resolution apparatus 104 composes 604 a second hierarchical dependency tree for a second local object model stored on a second client, the second local object model corresponding to a shared object model of an engineering object. In certain embodiments, the second hierarchical dependency tree is in a client specific format. In some embodiments, the editing module 304 composes 604 the second hierarchical dependency tree from a master hierarchical dependency tree and any changes made to the local object model on the client. All changes made to the local object model are depicted on the hierarchical dependency tree and a second hierarchical dependency tree is composed for the second client. In one embodiment, the hierarchical dependency tree may include feature and part dependencies for the second local object model.

In some embodiments, the Tree conflict resolution apparatus 104 compares 606 the first hierarchical dependency tree to the second hierarchical dependency tree. In certain embodiments, the dependency tree module 206 compares 606 the first hierarchical dependency tree to the second hierarchical dependency tree. In some embodiments, the dependency tree module 206 compares 606 the first hierarchical dependency tree to the second hierarchical dependency tree by first determining a first branch of the first hierarchical dependency tree upon which changes have been made, second, determining a second branch of the second hierarchical dependency tree upon which changes have been made and third, determining an intersection of the first branch of the first hierarchical dependency tree and the second branch of the second hierarchical dependency tree. The intersection of the first branch of the first hierarchical dependency tree and the second branch of the second hierarchical dependency tree is a common antecedent node (or common ancestor) of the changes. The common antecedent node is the point at which the changes in each hierarchical dependency tree overlap. All changes below the common antecedent node can be changed without error checking as the changes are compatible based on the hierarchical dependency trees. In other words, determining the common antecedent node determines that no conflict will occur to changes made below on the hierarchical dependency tree. The changes made to the local object models can be directly applied to the shared object model.

The Tree conflict resolution apparatus 104 merges 608 automatically a first change to the first local object model and a second change to the second local object model in the shared object model below a common antecedent node. As may be appreciated, the elements of the method 600 may occur in real-time, such that the hierarchical dependency trees are composed or updated immediately after modifications are made to the local object models. In addition, comparisons are performed in real-time, merging changes is performed in real-time, and so forth.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
an editing module that composes a first hierarchical dependency tree for a first local object model stored on a first client, the first local object model corresponding to a shared object model of an engineering object, and further composes a second hierarchical dependency tree for a second local object model stored on a second client, the second local object model corresponding to the shared object model;
a dependency tree module that compares the first hierarchical dependency tree to the second hierarchical dependency tree; and
a merging module that automatically merging a first change to the first local object model and a second change to the second local object model in the shared object model below a common antecedent node.

2. The apparatus of claim 1, wherein the dependency tree module determines the common antecedent node.

3. The apparatus of claim 2, wherein the dependency tree module determines a first branch on the first hierarchical dependency tree upon with the changes to the first local object model stored on the first client.

4. The apparatus of claim 3, wherein the dependency tree module determines a second branch on the second hierarchical dependency tree upon with the changes to the second local object model stored on the second client.

5. The apparatus of claim 4, wherein the dependency tree module determines an intersection of the first branch of the first hierarchical dependency tree and the second branch of the second hierarchical dependency tree to determine the common antecedent node for the changes.

6. The apparatus of claim 1, further comprising a storage module that stores the shared object model at a server, stores the first local object model on a first client, and stores the second local object model on a second client.

7. The apparatus of claim 1, wherein the merging module further delays changes above the common antecedent node.

8. A method comprising:
composing a first hierarchical dependency tree for a first local object model stored on a first client, the first local object model corresponding to a shared object model of an engineering object;
composing a second hierarchical dependency tree for a second local object model stored on a second client, the second local object model corresponding to the shared object model;
comparing the first hierarchical dependency tree to the second hierarchical dependency tree;
automatically merging a first change to the first local object model and a second change to the second local object model in the shared object model below a common antecedent node.

9. The method of claim 8, further comprising determining the common antecedent node.

10. The method of claim 9, further comprising determining a first branch on the first hierarchical dependency tree upon with the changes to the first local object model stored on the first client.

11. The method of claim 10, determining a second branch on the second hierarchical dependency tree upon with the changes to the second local object model stored on the second client.

12. The method of claim 11, further comprising determining an intersection of the first branch of the first hierarchical dependency tree and the second branch of the second hierarchical dependency tree to determine the common antecedent node for the changes.

13. The method of claim 8, further comprising:
storing the shared object model at a server;
storing the first local object model on a first client; and
storing the second local object model on a second client.

14. The method of claim 13, further comprising delaying changes above the common antecedent node.

15. A computer program product for dependency tree conflict resolution, the computer program product comprising a computer readable storage medium having program instructions embodied therewith, the program instructions executable by a processor to cause the processor to:
compose a first hierarchical dependency tree for a first local object model stored on a first client, the first local object model corresponding to a shared object model of an engineering object;
compose a second hierarchical dependency tree for a second local object model stored on a second client, the second local object model corresponding to the shared object model;
compare the first hierarchical dependency tree to the second hierarchical dependency tree; and
automatically merge a first change to the first local object model and a second change to the second local object model in the shared object model below a common antecedent node.

16. The computer program product of claim 15, wherein the program instructions executable by the processor further cause the processor to determine the common antecedent node.

17. The computer program product of claim 16, wherein the program instructions executable by the processor further cause the processor to determine a first branch on the first hierarchical dependency tree upon with the changes to the first local object model stored on the first client.

18. The computer program product of claim 17, wherein the program instructions executable by the processor further cause the processor to determine a second branch on the second hierarchical dependency tree upon with the changes to the second local object model stored on the second client.

19. The computer program product of claim 17, wherein the program instructions executable by the processor further cause the processor to determine an intersection of the first branch of the first hierarchical dependency tree and the second branch of the second hierarchical dependency tree to determine the common antecedent node for the changes.

20. The computer program product of claim 17, wherein the program instructions executable by the processor further cause the processor to store the shared object model at a server, store the first local object model on a first client, and store the second local object model on a second client.
